(19) United States
(12) Patent Application Publication
(10) Pub. No.: US 2022/0164927 A1
(43) Pub. Date: May 26, 2022

(54) METHOD AND SYSTEM OF STATISTICAL IMAGE RESTORATION FOR LOW-DOSE CT IMAGE USING DEEP LEARNING

(71) Applicant: KOREA INSTITUTE OF SCIENCE AND TECHNOLOGY, Seoul (KR)

(72) Inventor: Kihwan CHOI, Seoul (KR)

(73) Assignee: KOREA INSTITUTE OF SCIENCE AND TECHNOLOGY, Seoul (KR)

(21) Appl. No.: 17/535,682

(22) Filed: Nov. 25, 2021

(30) Foreign Application Priority Data
Nov. 26, 2020 (KR) 10-2020-0161272

(51) Int. Cl. G06T 5/00; G06N 3/04; G06T 11/00

(52) U.S. Cl. CPC G06T 5/002; G06T 2207/10081; G06T 11/003; G06N 3/04

(57) ABSTRACT

A method of statistical image restoration for a low-dose CT image using a deep learning, the method includes increasing a number of channels of the low-dose CT image, which is an input image, and decreasing a size of an activation map of the low-dose CT image using an encoder, passing the activation map generated by the encoder to a plurality of residual blocks, and increasing the size of the activation map passed through the residual blocks and generating a denoised result image using a decoder.

### PRIORITY STATEMENT

This application claims priority under 35 U.S.C. § 119 to Korean Patent Application No. 10-2020-0161272, filed on Nov. 26, 2020 in the Korean Intellectual Property Office (KIPO), the contents of which are herein incorporated by reference in their entireties.

### BACKGROUND

### 1. Technical Field

Embodiments relate to a method and a system of statistical image restoration for a low-dose CT image using a deep learning. More particularly, embodiments relate to a method and a system of statistical image restoration for a low-dose CT image capable of effectively reducing noise from the low-dose CT image.

### 2. Description of the Related Art

Computed tomography (CT) is the most commonly used imaging modality for quickly producing accurate medical images in clinical decision-making. However, the wide utilization of CT has increased concern about potential carcinogenesis since the radiation doses from CT scans are often much higher than those from other medical imaging devices. For example, an abdominal CT scan delivers a radiation dose approximately 50 times greater than that of an abdominal radiograph. Even worse is the accumulative risk of radiation dose exposure.

To reduce radiation exposure, dose reduction techniques including tube current modulation and lower tube voltage have been applied to low-dose CT (low-dose computed tomography, LDCT) imaging protocols, but the standard image reconstruction with filtered-backprojection (FBP) may not be the best reconstruction method due to excessive noise in the resultant images.

As an alternative approach to LDCT image reconstruction, iterative reconstruction (IR) methods have gained widespread interest and have been extensively studied in the past decades. In IR methods, data statistics and prior knowledge of the object have been incorporated into image reconstruction procedures. As a result of the promising image quality, CT platforms with IR have been widely deployed in clinics. However, the IR methods require excessive computational power and time especially for repeated forward and backward projections, which limit their clinical uses. Furthermore, unusual noise bias and loss of small low-contrast features can occasionally occur in IR images when prior knowledge of the object is incorrect.

### SUMMARY

Embodiments provide a method of statistical image restoration for a low-dose CT image using a deep learning capable of effectively reducing noise from the low-dose CT image.

Embodiments provide a system of the statistical image restoration for the low-dose CT image using the deep learning.

In an example method of statistical image restoration for a low-dose CT image using a deep learning, the method includes increasing a number of channels of the low-dose CT image, which is an input image, and decreasing a size of an activation map of the low-dose CT image using an encoder, passing the activation map generated by the encoder to a plurality of residual blocks, and increasing the size of the activation map passed through the residual blocks and generating a denoised result image using a decoder.

In an embodiment, the encoder may include a four convolution layers including a first layer, a second layer, a third layer and a fourth layer. A number of filters may increase from the first layer of the encoder to the fourth layer of the encoder. A size of the filter may decrease or be the same from the first layer of the encoder to the fourth layer of the encoder.

In an embodiment, each of the first to fourth layers of the encoder may operate a batch normalization and a ReLU activation.

In an embodiment, a size of a filter of the second layer of the encoder may be less than a size of a filter of the first layer of the encoder. A number of filters of the second layer of the encoder may be greater than a number of filters of the first layer of the encoder.

In an embodiment, a size of a filter of the third layer of the encoder may be same as the size of the filter of the second layer of the encoder. A number of filters of the third layer of the encoder may be greater than the number of filters of the second layer of the encoder.

In an embodiment, a size of a filter of the fourth layer of the encoder may be same as the size of the filter of the third layer of the encoder. A number of filters of the fourth layer of the encoder may be greater than the number of filters of the third layer of the encoder.

In an embodiment, one filter of the residual block may include a first convolution layer, a first bath normalization layer, a ReLU activation layer, a second convolution layer and a second bath normalization layer which are sequentially disposed.

In an embodiment, a number of filters of the residual block may be same as a number of filters of a fourth layer of the encoder.

In an embodiment, the residual blocks may maintain the size of the activation map generated by the encoder and the number of channels.

In an embodiment, the decoder may include a four deconvolution layers including a first layer, a second layer, a third layer and a fourth layer. A number of filters may decrease from the first layer of the decoder to the fourth layer of the decoder. A size of the filter may increases or be the same from the first layer of the decoder to the fourth layer of the decoder.

In an embodiment, each of the first to fourth layers of the decoder may operate a batch normalization and a ReLU activation.

In an embodiment, a size of a filter of the second layer of the decoder may be same as a size of a filter of the first layer of the decoder. A number of filters of the second layer of the decoder may be less than a number of filters of the first layer of the decoder.

In an embodiment, a size of a filter of the third layer of the decoder may be same as the size of the filter of the second layer of the decoder. A number of filters of the third layer of the decoder may be less than the number of filters of the second layer of the decoder.

In an embodiment, a size of a filter of the fourth layer of the decoder may be greater than the size of the filter of the third layer of the decoder. A number of filters of the fourth layer of the decoder may be less than the number of filters of the third layer of the decoder.

In an embodiment, the number of filters of the first layer of the decoder may be same as a number of filters of a third layer of the encoder. The number of filters of the second layer of the decoder may be same as a number of filters of a second layer of the encoder. The number of filters of the third layer of the decoder may be same as a number of filters of a first layer of the encoder.

In an embodiment, the method may further include receiving the denoised result image and outputting a probability map using a discriminator.

In an embodiment, the discriminator may include a first layer, a second layer, a third layer, a fourth layer, a fifth layer and a sixth layer. Sizes of filters of the first to sixth layers of the discriminator may be same as each other. A number of filters may increase from the first layer of the discriminator to the fifth layer of the discriminator.

In an embodiment, the first layer of the discriminator may be a convolution layer. A Leaky ReLU activation may be operated in the first layer. The second to fourth layers of the discriminator may be convolution layers. An instance normalization and the Leaky ReLU activation may be operated in the second to fourth layers. The fifth and sixth layers of the discriminator may be convolution layers.

In an embodiment, the method may further include training a network based on a loss function representing a difference between the denoised result image and a normal-dose CT image (NDCT) which is a target image corresponding to the input image (the low-dose CT image, LDCT).

In an embodiment, an objective function LstatCNN(G) may be formulated by combining a LDCT statistics loss Lstats(G) and a NDCT style transfer loss Lstyle(G). A control parameter may be λₛₜₐₜₛ. [symbol] _{statCNN}(G)= [symbol] _{style}(G)+λₛₜₐₜₛ [symbol] ₛₜₐₜₛ(G) may be satisfied.

In an embodiment, the LDCT statistical loss may represent a Euclidean distance between the denoised result image generated by the input image passing through the encoder, the residual blocks and the decoder and the target image. The NDCT style transfer loss may represent a difference between [symbol] ₁-norm of the denoised result image and [symbol] ₁-norm of the target image.

In an embodiment, the LDCT statistical loss Lstats(G) is [symbol] ₛₜₐₜₛ(G)= [symbol] _{(X,Y)}[(G(x)−y)^{T}Dₓ⁻¹(G(x)−y)], a sinogram bi calculated from a LDCT projection data is bᵢ=log(Iₒ/Iᵢ), Io is a blank photon intensity and Ii is a measured photon intensity, Iᵢ˜Poisson(I₀exp([−Axₜᵣᵤₑ]ᵢ)) is satisfied, A is a forward projection operator, a covariance matrix of b is Σ_{b}=diag(σ_{b}_{ᵢ}², . . . , σ_{b}_{ₘ}²), m (≥n) is a number of line integrals in the sinogram. If A^{†} denotes a left inverse of A an (A^{†})^{T} denotes a transpose of A^{†}, b≅Ax and x≈A^{†}b. A covariance matrix of x is Σₓ=A^{†}Σ_{b}(A^{†})^{T}, A^{†}=A_{L}^{T}H, A_{L}^{T} denotes a locally weighted backprojection and H denotes a filter kernel. G(X) is the denoised result image and y is the target image. Dx is a diagonal entries of Σx, Dₓ=diag(σₓ_{₁}², . . . σₓ_{ₙ}²), σₓ_{ᵢ}² is σₓ_{ᵢ}²=eᵢ^{T} A_{L}^{T} HΣₗ, H^{T} A_{L}eᵢ and eᵢ is a unit vector of an i-th point image.

In an embodiment, the NDCT style transfer loss Lstyle(G) may be [symbol] _{style}(G)= [symbol] _{(X,Y)} [∥G(x)−y [symbol] ᵢ]. G(X) is the denoised result image and y is the target image.

In an example, a program for executing the method of the statistical image restoration for the low-dose CT image using the deep learning by a computer may be stored in a non-transitory computer-readable storage medium.

In an example system of statistical image restoration for a low-dose CT image using a deep learning, the system includes an encoder, a plurality of residual blocks and a decoder. The encoder is configured to increase a number of channels of the low-dose CT image, which is an input image, and to decrease a size of an activation map of the low-dose CT image. The plurality of residual blocks is configured to pass the activation map generated by the encoder. The decoder is configured to increase the size of the activation map passed through the residual blocks and to generate a denoised result image.

In an embodiment, the system may further include a discriminator configured to receive the denoised result image and to output a probability map.

In an embodiment, a network may be trained based on a loss function representing a difference between the denoised result image and a normal-dose CT image (NDCT) which is a target image corresponding to the input image (the low-dose CT image, LDCT).

According to the method and the system of the statistical image restoration for the low-dose CT image using the deep learning, the noise level may be successfully reduced for the low-dose CT image which is the input image. In addition, the image details may be restored without adding artifacts. In addition, the image quality of LDCT may be restored without loss of anatomical information.

### BRIEF DESCRIPTION OF THE DRAWINGS

The above and other features and advantages of the present inventive concept will become more apparent by describing in detailed embodiments thereof with reference to the accompanying drawings, in which:

FIG. 1 is a diagram illustrating a model architecture of an image restoration generator of a system of statistical image restoration for a low-dose CT image according to an embodiment of the present inventive concept;

FIG. 2 is a diagram illustrating a residual block of the image restoration generator of FIG. 1;

FIG. 3 is a diagram illustrating a model architecture of an image restoration discriminator of the system of the statistical image restoration for the low-dose CT image of FIG. 1;

FIG. 4 is a diagram illustrating an example of an input image of the system of the statistical image restoration for the low-dose CT image of FIG. 1;

FIG. 5 is a diagram illustrating an example of an output image of the system of the statistical image restoration for the low-dose CT image of FIG. 1 corresponding to the input image of FIG. 4;

FIG. 6 is a diagram illustrating a normal-dose CT image corresponding to the input image of FIG. 4;

FIG. 7 is a diagram illustrating an example of an input image of the system of the statistical image restoration for the low-dose CT image of FIG. 1;

FIG. 8 is a diagram illustrating an example of an output image of the system of the statistical image restoration for the low-dose CT image of FIG. 1 corresponding to the input image of FIG. 7;

FIG. 9 is a diagram illustrating a normal-dose CT image corresponding to the input image of FIG. 7;

FIG. 10 is a diagram illustrating an example of an input image of the system of the statistical image restoration for the low-dose CT image of FIG. 1;

FIG. 11 is a diagram illustrating an example of an output image of the system of the statistical image restoration for the low-dose CT image of FIG. 1 corresponding to the input image of FIG. 10;

FIG. 12 is a diagram illustrating a normal-dose CT image corresponding to the input image of FIG. 10;

FIG. 13 is a diagram illustrating an example of an input image of the system of the statistical image restoration for the low-dose CT image of FIG. 1;

FIG. 14 is a diagram illustrating an example of an output image of the system of the statistical image restoration for the low-dose CT image of FIG. 1 corresponding to the input image of FIG. 13;

FIG. 15 is a diagram illustrating a normal-dose CT image corresponding to the input image of FIG. 13;

FIG. 16 is a diagram illustrating an example of an input image of the system of the statistical image restoration for the low-dose CT image of FIG. 1;

FIG. 17 is a diagram illustrating an example of an output image of the system of the statistical image restoration for the low-dose CT image of FIG. 1 corresponding to the input image of FIG. 16;

FIG. 18 is a diagram illustrating an example of an input image of the system of the statistical image restoration for the low-dose CT image of FIG. 1; and

FIG. 19 is a diagram illustrating an example of an output image of the system of the statistical image restoration for the low-dose CT image of FIG. 1 corresponding to the input image of FIG. 18.

### DETAILED DESCRIPTION OF THE EMBODIMENTS

The present inventive concept now will be described more fully hereinafter with reference to the accompanying drawings, in which exemplary embodiments of the present invention are shown. The present inventive concept may, however, be embodied in many different forms and should not be construed as limited to the exemplary embodiments set fourth herein.

Rather, these exemplary embodiments are provided so that this disclosure will be thorough and complete, and will fully convey the scope of the present invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the inventive concept as used herein.

Hereinafter, the present inventive concept will be explained in detail with reference to the accompanying drawings.

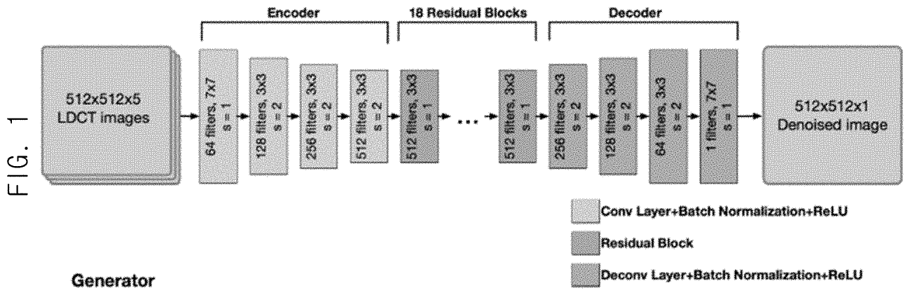

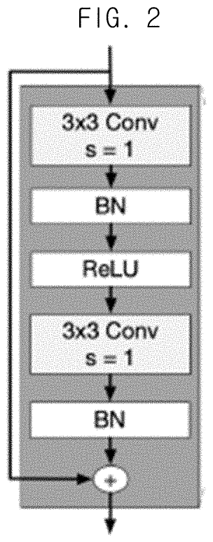

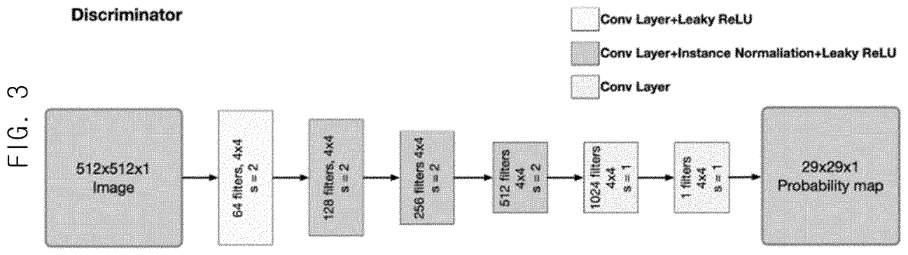

FIG. 1 is a diagram illustrating a model architecture of an image restoration generator of a system of statistical image restoration for a low-dose CT image according to an embodiment of the present inventive concept. FIG. 2 is a diagram illustrating a residual block of the image restoration generator of FIG. 1. FIG. 3 is a diagram illustrating a model architecture of an image restoration discriminator of the system of the statistical image restoration for the low-dose CT image of FIG. 1.

Referring to FIGS. 1 to 3, a deep learning may be used as a means of reducing noise in images. Deep convolutional neural networks (CNNs) may be trained to transfer high-quality image features of normal-dose computed tomography (NDCT) images to LDCT images. However, existing deep learning approaches for denoising images often overlook the statistical property of CT images.

In the present embodiment, an approach to the statistical image restoration for LDCT using the deep learning may be proposed. A loss function to incorporate the noise property in image domain derived from the noise statistics in sinogram domain may be introduced. In order to capture the spatially-varying statistics of CT images, the receptive fields of the neural network may be increased to cover full-size CT slices. In addition, the network of the present embodiment utilizes z-directional correlation by taking multiple consecutive CT slices as input.

For performance evaluation, the networks of the present embodiment may be trained and validated with a public dataset consisting of LDCT-NDCT image pairs. A retrospective study may be performed by testing the networks with clinical LDCT images. The experimental results show that the denoising networks may successfully reduce the noise level and restore the image details without adding artifacts. The present embodiment may demonstrate that the statistical deep learning approach may restore the image quality of LDCT without loss of anatomical information.

In recent years, the deep learning has become a dominant machine learning tool in visual recognition and image processing. The convolutional neural networks (CNNs), which are successful in human-level image classification, may be applied to the tasks of object localization and semantic segmentation by extracting patches and sliding a window. For computational efficiency and accuracy, fully convolutional network architectures may be proposed to handle full-size images without extracting patches. Based on the fully convolutional network, generative adversarial networks (GANs) may also been proposed as a means of generating realistic images with a small number of training examples.

Such advances in deep learning may be used to denoise LDCT images. The present embodiment may propose to reduce noise in LDCT images by training CNNs with LDCT-NDCT image pairs. When reducing noise in LDCT images by training CNNs with LDCT-NDCT image pairs, a patchwise learning, which crops the original images into overlapped sub-images for training, may be performed. However, with smaller receptive fields, patchwise CNNs may decrease the number of network parameters to fit the number of training samples. For prediction, the trained CNN may move around an input image as a sliding window, resulting in overlapped sub-images. Although the patchwise learning may be useful in training CNNs with a limited number of images, the patchwise learning may not reuse feature maps from lower layers, which may result in computational inefficiency. In addition, reduced receptive fields may not incorporate the spatially-varying CT noise property since sliding a window is shift-invariant.

In the present embodiment, the deep learning framework for statistical low-dose CT image restoration to incorporate the noise property of CT images into the learning process may be used. According to the present embodiment, the receptive fields of networks may be increased to capture image wide CT noise properties. In addition, a loss function to model the noise statistics of CT images may be explained. In addition, the proposed network may have 2.5-dimensional processing pipelines to utilize z-directional correlation as well as axial correlation in CT slices. In addition, the proposed network may be thoroughly evaluated using leave-one-out cross-validation, which divides the dataset into training and validation splits for more realistic experiments. In addition, a retrospective study may be performed to test the networks with clinical LDCT images. Through this, it is shown that the method according to the present embodiment outperforms the existing denoising methods in both quantitative and qualitative metrices.

The network architecture of the present embodiment of FIG. 1 may extend a contemporary deep neural network to increase receptive fields both in the axial plane and in the z-direction.

In the present embodiment, the network of FIG. 1 may be applied to increase the receptive fields to capture CT noise statistics and restore corrupted anatomical information. The proposed network of the present embodiment is implemented into two types: StatCNN and StatGAN. While StatCNN is a fully convolutional network that denoises LDCT images and generates high-quality images, StatGAN, a generative adversarial network, is an extended version of StatCNN with an adversarial loss. As part of the GAN structure, StatCNN can be regarded as the generator of StatGAN. The architecture of the proposed network is described in FIGS. 1 to 3. For each layer, the number, size, and stride of filters are represented.

As shown in FIGS. 1 to 3, the receptive field may be increased to cover a whole CT axial slice with a deeper network structure. In addition, z-directional correlation may be utilized among consecutive CT slices, which results in 2.5-dimensional network pipelines.

Since medical images typically have a small slice thickness and interval, adjacent slices are highly correlated in z-direction and therefore the z-directional correlation may be very useful in image restoration for LDCT. As input to the proposed network, 512×512×5 LDCT images may be used. 512×512×5 LDCT images may be generated by stacking adjacent LDCT slices, the central slice of which corresponds to the target NDCT slice.

The image restoration generator StatCNN may include an encoder, a plurality of residual blocks and a decoder. As shown in FIG. 1, the encoder may shrink the activation map size while increasing the number of channels. Each layer of the encoder may be followed by a batch normalization and ReLU activation. The encoder may include four convolution layers. The activation map generated by the encoder may pass to the plurality of residual blocks for image translation from LDCT to NDCT. For example, the number of the residual blocks may be eighteen. The residual blocks, which are built with residual bottlenecks and skip connections, may maintain the activation map size as well as the number of channels. The activation map size may be then expanded again by the decoder. The decoder may use three deconvolution layers to enlarge the representation size and one output layer to produce the final image.

Since the generators' architecture is fully convolutional network, so that the proposed network may handle full-size images as input without pre- and post-processing in both training and prediction phases.

As shown in FIG. 1, for example, the input of the encoder is 512×512×5 LDCT images. For example, the encoder may include four convolution layers. The number of filters may gradually increase from a first layer of the encoder to a fourth layer of the encoder. The size of the filter may gradually decrease or be the same from the first layer of the encoder to the fourth layer of the encoder. The stride of the filter may gradually increase or be the same from the first layer of the encoder to the fourth layer of the encoder.

Each of the first to fourth layers of the encoder may operate the batch normalization and the ReLU activation.

For example, the first layer of the encoder may include 64 filters. Each of the filters of the first layer of the encoder may have a size of 7×7 and a stride of 1.

For example, the size of the filter of the second layer of the encoder may be less than the size of the filter of the first layer of the encoder. The number of the filters of the second layer of the encoder may be greater than the number of the filters of the first layer of the encoder. For example, the second layer of the encoder may include 128 filters. Each of the filters of the second layer of the encoder may have a size of 3×3 and a stride of 2.

For example, the size of the filter of the third layer of the encoder may be the same as the size of the filter of the second layer of the encoder. The number of the filters of the third layer of the encoder may be greater than the number of the filters of the second layer of the encoder. For example, the third layer of the encoder may include 256 filters. Each of the filters of the third layer of the encoder may have a size of 3×3 and a stride of 2.

For example, the size of the filter of the fourth layer of the encoder may be the same as the size of the filter of the third layer of the encoder. The number of the filters of the fourth layer of the encoder may be greater than the number of the filters of the third layer of the encoder. For example, the fourth layer of the encoder may include 512 filters. Each of the filters of the fourth layer of the encoder may have a size of 3×3 and a stride of 2.

The output of the encoder may pass to the plurality of residual blocks. For example the number of the residual blocks may be 18.

The number of the filters, the sizes of the filters and the strides of the filters of the residual blocks may be the same as each other. For example, each of first to eighteenth residual blocks may include 512 filters. Each of the filters of the first to eighteenth residual blocks may have a size of 3×3 and a stride of 1.

As shown in FIG. 2, one filter of the residual block may include a first convolution layer having a size of 3×3 and a stride of 1, a first bath normalization layer, a ReLU activation layer, a second convolution layer having a size of 3×3 and a stride of 1 and a second bath normalization layer. The first convolution layer, the first bath normalization layer, the ReLU activation layer, the second convolution layer and the second bath normalization layer may be sequentially disposed in the filter of the residual block.

For example, the output of the decoder may be 512×512×1 denoised images. For example, the decoder may include four deconvolution layers. A fourth layer of the decoder may be an output layer. The number of filters may gradually decrease from a first layer of the decoder to the fourth layer of the decoder. The size of the filter may gradually increase or be the same from the first layer of the decoder to the fourth layer of the decoder. The stride of the filter may gradually decrease or be the same from the first layer of the decoder to the fourth layer of the decoder.

Each of the first to fourth layers of the decoder may operate the batch normalization and the ReLU activation.

For example, the first layer of the decoder may include 256 filters. Each of the filters of the first layer of the decoder may have a size of 3×3 and a stride of 2.

For example, the size of the filter of the second layer of the decoder may be same as the size of the filter of the first layer of the decoder. The number of the filters of the second layer of the decoder may be less than the number of the filters of the first layer of the decoder. For example, the second layer of the decoder may include 128 filters. Each of the filters of the second layer of the decoder may have a size of 3×3 and a stride of 2.

For example, the size of the filter of the third layer of the decoder may be the same as the size of the filter of the second layer of the decoder. The number of the filters of the third layer of the decoder may be less than the number of the filters of the second layer of the decoder. For example, the third layer of the decoder may include 64 filters. Each of the filters of the third layer of the decoder may have a size of 3×3 and a stride of 2.

For example, the size of the filter of the fourth layer of the decoder may be greater than the size of the filter of the third layer of the decoder. The number of the filters of the fourth layer of the decoder may be less than the number of the filters of the third layer of the decoder. For example, the fourth layer of the decoder may include one filter. The filter of the fourth layer of the decoder may have a size of 7×7 and a stride of 1.

As shown in FIG. 3, an input of the discriminator may be 512×512×1 images, the input of the discriminator may be the output of the generator. An output of the discriminator may be a 29×29×1 probability map.

For example, the discriminator may include six layers. Sizes of filters of first to sixth layers of the discriminator may be the same as each other. The number of the filters may increase from a first layer of the discriminator to a fifth layer of the discriminator. The stride of the filter may gradually decrease or be the same from the first layer of the discriminator to the sixth layer of the discriminator.

The first layer of the discriminator may be a convolution layer. The Leaky ReLU activation may be operated in the first layer of the discriminator. The second to fourth layers of the discriminator may be convolution layers. Instance normalization and the Leaky ReLU activation may be operated in the second to fourth layers of the discriminator. The fifth and sixth layers of the discriminator may be convolution layers.

For example, the first layer of the discriminator may include 64 filters. Each of the filters of the first layer of the discriminator may have a size of 4×4 and a stride of 2. For example, the second layer of the discriminator may include 128 filters. Each of the filters of the second layer of the discriminator may have a size of 4×4 and a stride of 2. For example, the third layer of the discriminator may include 256 filters. Each of the filters of the third layer of the discriminator may have a size of 4×4 and a stride of 2. For example, the fourth layer of the discriminator may include 512 filters. Each of the filters of the fourth layer of the discriminator may have a size of 4×4 and a stride of 2. For example, the fifth layer of the discriminator may include 1024 filters. Each of the filters of the fifth layer of the discriminator may have a size of 4×4 and a stride of 1. For example, the sixth layer of the discriminator may include one filter. The filter of the sixth layer of the discriminator may have a size of 4×4 and a stride of 1.

The loss function of the present embodiment represents the difference between the noise-reduced image from the NDCT image, which is the output image of the generator and the NDCT image. Hereinafter, the loss function of the present embodiment is explained. An LDCT-NDCT dataset (X, Y) is a set of pairs of the input image and the target image. The goal is to learn a network G: x→y mapping between two domains X and Y with paired training samples (x, y) ∈ (X, Y). Here, the paired samples x ∈ [symbol] ⁿ and y ∈ [symbol] ⁿ are the vector expressions of a noisy LDCT image and a high-quality NDCT image, respectively. For an image pair (x, y), it is denoted that G(x) is the resultant image from neural network G with the input of LDCT image x. As described above, the input of the neural network may be a stack of consecutive LDCT slices. The notation may be simplified by G(x)=G(x; x_{-B}, . . . , −1,1, . . . B), where xk denotes the k-th adjacent slice of x, and thus, an input stack has 2B+1 slices.

1) LDCT Statistical Loss is explained as follows. We assume that an LDCT image x may be represented by the sum of the noiseless image xₜᵣᵤₑ and additive noise ϵ: x=xₜᵣᵤₑ+ϵ.

From the LDCT projection data, the sinogram bi may be calculated by: bᵢ=log(I₀/Iᵢ). Herein, Iₒ and Ii are blank photon intensity and measured photon intensity, respectively. We assume that Ii's are independent and Iᵢ˜Poisson (I₀exp([−Axₜᵣᵤₑ]ᵢ)), where A is the forward projection operator. Then, the covariance matrix of b is given by: Σ_{b}=diag(σ_{b}_{₁}², . . . , σ_{b}_{ₘ}²). Herein,

$${σ}_{{b}_{i}}^{2} \approx \frac{var ( {I}_{i} )}{{( E ( {I}_{i} ) ]}^{2}} ∝ exp ( {[ {Ax}_{true} ]}_{i} )$$

and m (≥n) is the number of the line integrals in the sinogram. Although the true sinogram Axₜᵣᵤₑ is not available in general, NDCT sinogram may be used as an approximate of the true sinogram. If A^{†} denotes the left inverse of A and (A^{†})^{T} denotes the transpose of A^{†}, respectively, b≈Ax and x≈A^{†}b. Then, the covariance matrix of x may be given by: Σₓ=A^{†}σ_{b}(A^{†})^{T}, which may be calculated by using filtered backprojection (FBP) for the left inverse of A, i.e., A^{†}=A_{L}^{T}H. Here A_{L}^{T} denotes a locally weighted backprojection and H denotes a filter kernel, respectively. Since G(x) is the denoised image from the input x, a statistical loss function for LDCT may be formulated as the following: [symbol] ₛₜₐₜₛ^{sino}(G)= [symbol] _{(X,Y)} [(G(x)−y)^{T}Σₓ⁻¹(G(x)−y)].

Herein, the covariance matrix Σx is a large matrix in [symbol] ^{n×n}. In order to reduce computational complexity, the covariance matrix Σx may be approximated with its diagonal entries Dₓ=diag(σₓ_{ᵢ}², . . . , σₓ_{ₙ}²).

Then, σₓ_{ᵢ}² may be calculated as the following: σₓ_{ᵢ}²=eᵢ^{T}A_{L}^{T}HΣ_{b}H^{T}A_{L}eᵢ. Herein, the unit vector eᵢ corresponds to i-th point image. With the simplification, the LDCT statistical loss function is given by: [symbol] ₛₜₐₜₛ(G)= [symbol] _{(X,Y)}[(G(x)−y)^{T}Dₓ⁻¹(G(x)−y)].

Herein, we assume noise across the image pixels to be independent and unbiased, i.e., [symbol] [ϵϵ^{T}]≈Dₓ. Since Dx depends on the NDCT sinogram, the statistical weights may be calculated offline. Note that Dx varies with respect to image pairs (x, y) in the training set (X, Y).

2) NDCT Style Transfer Loss is explained as follows. The [symbol] ₂-norm loss function for image generation may accurately capture low-frequency information, but may result in blurry images. To transfer the image style of NDCT, [symbol] -norm may be used and the style loss function may be defined by: [symbol] _{style}(G)= [symbol] _{(X, Y)}[∥G(x)−y∥ [symbol] ].

To formulate an objective function for the proposed network, LDCT statistics loss Lstats(G) may be combined with NDCT style transfer loss Lstyle(G): [symbol] _{statCNN}(G)= [symbol] _{style}(G)+λₛₜₐₜₛ [symbol] ₛₜₐₜₛ(G).

Herein, λₛₜₐₜₛ may be a control parameter of the relative importance between statistics loss and style transfer loss terms. When the LDCT statistical loss term is relatively important, λₛₜₐₜₛ may be set to be great. In contrast, when the NDCT style transfer loss term is relatively important, λₛₜₐₜₛ may be set to be little.

The objective function may be used to train the image pair of LDCT and NDCT. The LDCT statistical loss may represent a Euclidean distance between the noise-reduced image generated of the LDCT image generated through the generator and the NDCT image which is the target reference image. The LDCT statistical loss of the present embodiment may reflect an importance of a pixel. The importance of the pixel in the image domain may be derived from photon statistics of projection data. The NDCT style transfer loss function may mean a function that allows an image from which noise has been reduced to have a style similar to a style of the NDCT image which is the target reference image. The NDCT style transfer loss function may allow the proposed network to train such that the difference between [symbol] ₁-norm of the denoised image and [symbol] ₁-norm of the target reference image is small.

The network parameters for the proposed network may be obtained by optimizing a minimization problem:

$${G}^{+} = arg {min}_{G} {ℒ}_{statCNN} ( G ) .$$

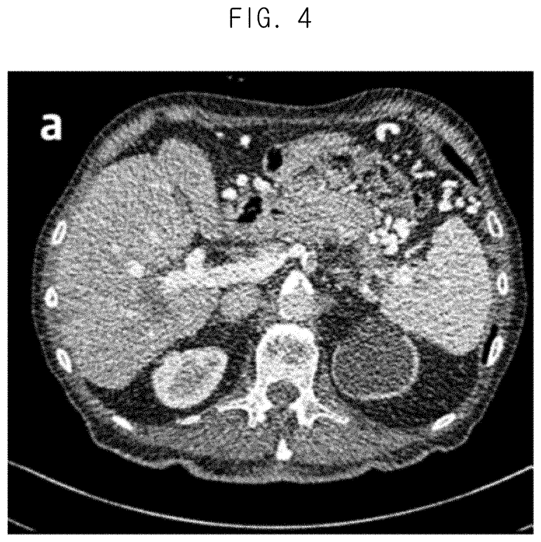

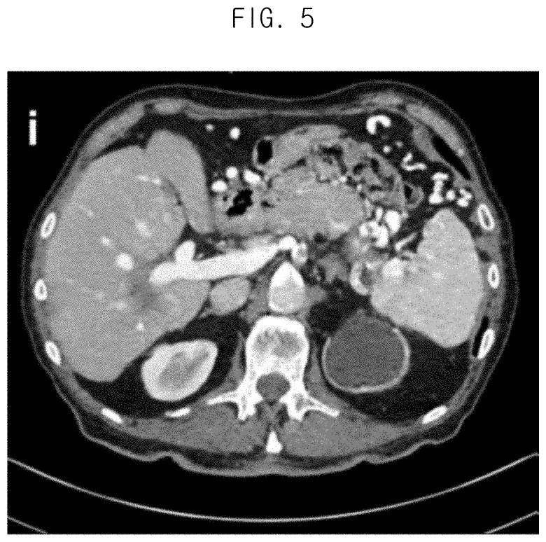

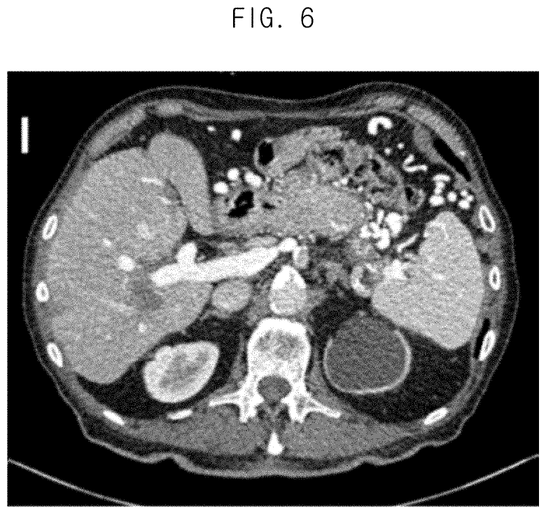

FIG. 4 is a diagram illustrating an example of an input image of the system of the statistical image restoration for the low-dose CT image of FIG. 1. FIG. 5 is a diagram illustrating an example of an output image of the system of the statistical image restoration for the low-dose CT image of FIG. 1 corresponding to the input image of FIG. 4. FIG. 6 is a diagram illustrating a normal-dose CT image corresponding to the input image of FIG. 4.

Referring to FIGS. 1 to 6, for performance evaluation, the proposed networks are trained and validated with a public dataset consisting of LDCT-NDCT image pairs.

FIG. 4 represents LDCT input image in a patient's axial direction. FIG. 5 represents an output image in which noise of the LDCT input image of FIG. 4 is reduced, and FIG. 6 represents a target image corresponding to the LDCT input image of FIG. 4.

Referring to the output image of FIG. 5, the noise may be effectively reduced compared to the input image of FIG. 4, and the output image of FIG. 5 may be similar to the target image of FIG. 6.

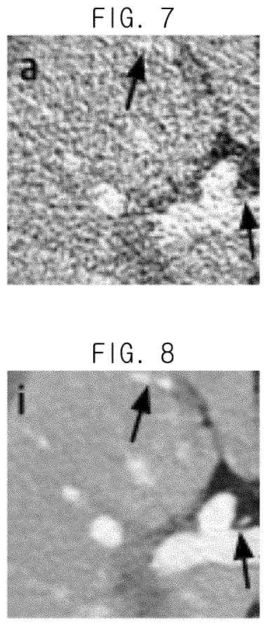

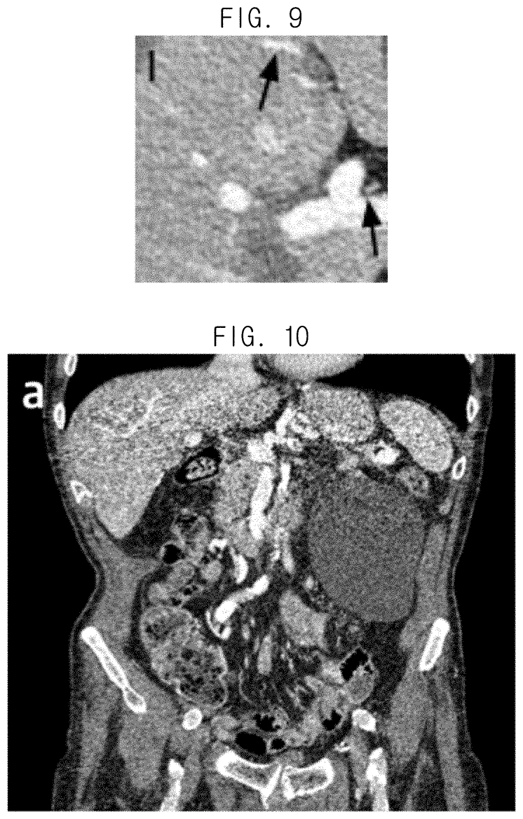

FIG. 7 is a diagram illustrating an example of an input image of the system of the statistical image restoration for the low-dose CT image of FIG. 1. FIG. 8 is a diagram illustrating an example of an output image of the system of the statistical image restoration for the low-dose CT image of FIG. 1 corresponding to the input image of FIG. 7. FIG. 9 is a diagram illustrating a normal-dose CT image corresponding to the input image of FIG. 7.

FIG. 7 is an image in which a region of interest (ROI) of the axial slice of the patient of the LDCT input image of FIG. 4 is indicated by arrows in order to better evaluate the image quality. FIG. 8 represents an output image in which noise of the LDCT input image of FIG. 7 is reduced, and FIG. 9 represents a target image corresponding to the LDCT input image of FIG. 7.

As shown in FIG. 8, the proposed network produced images of high quality while restoring edges of a small venous branch near falciform ligament as indicated with the upper arrows. In addition, the proposed network also successfully restored and visualized the portal vein and the adjacent small structure as indicated with the lower arrows.

As shown in the output image of FIG. 8, the noise may be effectively reduced compared to the input image of FIG. 7.

In FIGS. 5 and 8, the noise of the input image may be efficiently reduced by the extended receptive field and image information may be well restored.

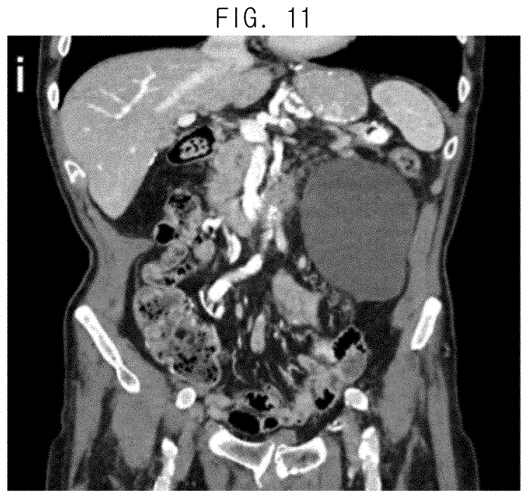

FIG. 10 is a diagram illustrating an example of an input image of the system of the statistical image restoration for the low-dose CT image of FIG. 1. FIG. 11 is a diagram illustrating an example of an output image of the system of the statistical image restoration for the low-dose CT image of FIG. 1 corresponding to the input image of FIG. 10. FIG. 12 is a diagram illustrating a normal-dose CT image corresponding to the input image of FIG. 10.

FIG. 10 represents LDCT input image in a patient's coronal direction. FIG. 11 represents an output image in which noise of the LDCT input image of FIG. 10 is reduced, and FIG. 12 represents a target image corresponding to the LDCT input image of FIG. 10.

Referring to the output image of FIG. 11, the noise may be effectively reduced compared to the input image of FIG. 10, and the output image of FIG. 11 may be similar to the target image of FIG. 12.

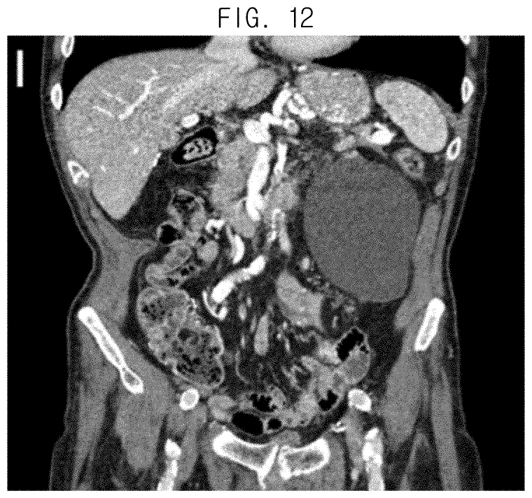

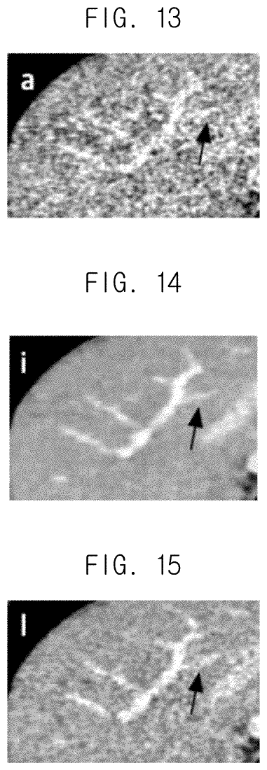

FIG. 13 is a diagram illustrating an example of an input image of the system of the statistical image restoration for the low-dose CT image of FIG. 1. FIG. 14 is a diagram illustrating an example of an output image of the system of the statistical image restoration for the low-dose CT image of FIG. 1 corresponding to the input image of FIG. 13. FIG. 15 is a diagram illustrating a normal-dose CT image corresponding to the input image of FIG. 13.

FIG. 13 is an image in which a region of interest (ROI) of the coronal slice of the patient of the LDCT input image of FIG. 10 is indicated by arrows in order to better evaluate the image quality. FIG. 14 represents an output image in which noise of the LDCT input image of FIG. 13 is reduced, and FIG. 15 represents a target image corresponding to the LDCT input image of FIG. 13.

The proposed network may successfully reconstruct anatomical information in the z-direction trained by the neural network with axial slices. The proposed network clearly showed the portal venous branches.

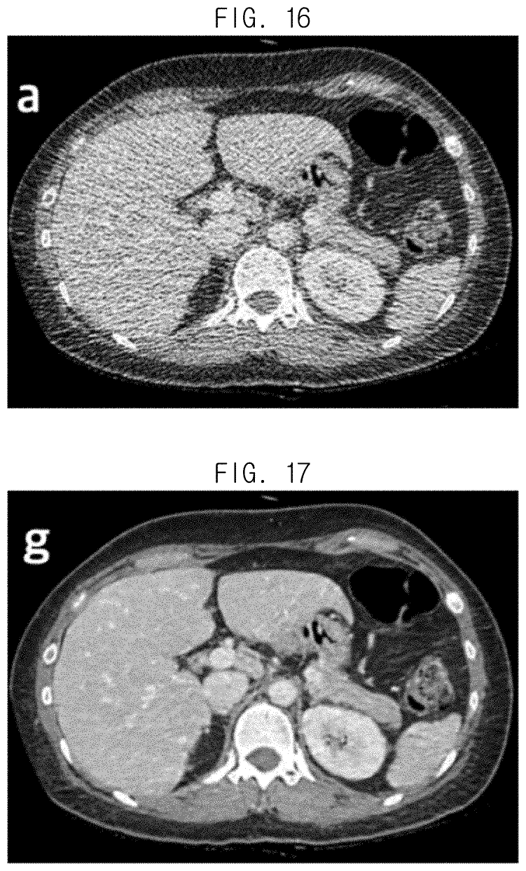

FIG. 16 is a diagram illustrating an example of an input image of the system of the statistical image restoration for the low-dose CT image of FIG. 1. FIG. 17 is a diagram illustrating an example of an output image of the system of the statistical image restoration for the low-dose CT image of FIG. 1 corresponding to the input image of FIG. 16.

Referring to FIGS. 1 to 17, after training on an open data set, the network was tested with clinical LDCT images.

FIG. 16 represents LDCT input image in a patient's axial direction. FIG. 17 represents an output image in which noise of the LDCT input image of FIG. 16 is reduced.

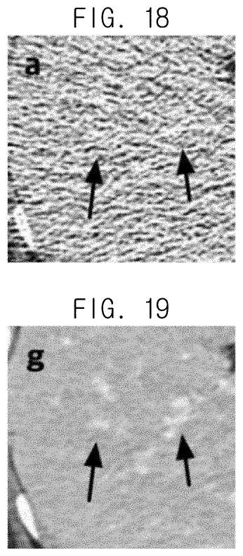

FIG. 18 is a diagram illustrating an example of an input image of the system of the statistical image restoration for the low-dose CT image of FIG. 1. FIG. 19 is a diagram illustrating an example of an output image of the system of the statistical image restoration for the low-dose CT image of FIG. 1 corresponding to the input image of FIG. 18.

FIG. 18 is an image in which a region of interest (ROI) of the axial slice of the patient of the LDCT input image of FIG. 16 is indicated by arrows in order to better evaluate the image quality. FIG. 19 represents an output image in which noise of the LDCT input image of FIG. 18 is reduced.

The proposed network produced high-quality images by reconstructing the small veins indicated by arrows in FIG. 19.

In the present embodiment, the network which incorporates CT noise statistics for LDCT image restoration is proposed. To capture the spatially-varying noise pattern of CT images, a contemporary network may be extended to a deeper network, the receptive fields of which may cover full-size images in the axial plane. By taking stacked CT slices as input, the proposed network may utilize the spatial correlation in z-direction and restore small and subtle structures.

While capturing the noise pattern from the NDCT images, the proposed network may efficiently restore the anatomical information from the 2.5-dimensional LDCT slice stacks. With the use of a loss function incorporating the noise statistics of CT images, the proposed network may successfully reduce noise level and restore anatomical information.

According to an embodiment of the present inventive concept, a non-transitory computer-readable storage medium having stored thereon program instructions of the method of statistical image restoration for a low-dose CT image using a deep learning may be provided. The above mentioned method may be written as a program executed on the computer. The method may be implemented in a general purpose digital computer which operates the program using a computer-readable medium. In addition, the structure of the data used in the above mentioned method may be written on a computer readable medium through various means. The computer readable medium may include program instructions, data files and data structures alone or in combination. The program instructions written on the medium may be specially designed and configured for the present inventive concept, or may be generally known to a person skilled in the computer software field. For example, the computer readable medium may include a magnetic medium such as a hard disk, a floppy disk and a magnetic tape, an optical recording medium such as CD-ROM and DVD, a magneto-optical medium such as floptic disc and a hardware device specially configured to store and execute the program instructions such as ROM, RAM and a flash memory. For example, the program instructions may include a machine language codes produced by a compiler and high-level language codes which may be executed by a computer using an interpreter or the like. The hardware device may be configured to operate as one or more software modules to perform the operations of the present inventive concept.

In addition, the above mentioned method of statistical image restoration for a low-dose CT image using a deep learning may be implemented in a form of a computer-executed computer program or an application which are stored in a storage method.

The present inventive concept is related to the method and the system of statistical image restoration for a low-dose CT image using a deep learning, and the noise level may be successfully reduced for the low-dose CT image which is the input image. In addition, the image details may be restored without adding artifacts. In addition, the image quality of LDCT may be restored without loss of anatomical information.

The foregoing is illustrative of the present inventive concept and is not to be construed as limiting thereof. Although a few embodiments of the present inventive concept have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims. The present inventive concept is defined by the following claims, with equivalents of the claims to be included therein.

What is claimed is:

1. A method of statistical image restoration for a low-dose CT image using a deep learning, the method comprising:
increasing a number of channels of the low-dose CT image, which is an input image, and decreasing a size of an activation map of the low-dose CT image using an encoder;
passing the activation map generated by the encoder to a plurality of residual blocks; and
increasing the size of the activation map passed through the residual blocks and generating a denoised result image using a decoder.

2. The method of claim 1,
wherein the encoder includes a four convolution layers including a first layer, a second layer, a third layer and a fourth layer,
wherein a number of filters increases from the first layer of the encoder to the fourth layer of the encoder; and
wherein a size of the filter decreases or is the same from the first layer of the encoder to the fourth layer of the encoder.

3. The method of claim 2,
wherein each of the first to fourth layers of the encoder operates a batch normalization and a ReLU activation.

4. The method of claim 2, wherein a size of a filter of the second layer of the encoder is less than a size of a filter of the first layer of the encoder, and
wherein a number of filters of the second layer of the encoder is greater than a number of filters of the first layer of the encoder.

5. The method of claim 4, wherein a size of a filter of the third layer of the encoder is same as the size of the filter of the second layer of the encoder, and
wherein a number of filters of the third layer of the encoder is greater than the number of filters of the second layer of the encoder.

6. The method of claim 5, wherein a size of a filter of the fourth layer of the encoder is same as the size of the filter of the third layer of the encoder, and
wherein a number of filters of the fourth layer of the encoder is greater than the number of filters of the third layer of the encoder.

7. The method of claim 1, wherein one filter of the residual block includes a first convolution layer, a first bath normalization layer, a ReLU activation layer, a second convolution layer and a second bath normalization layer which are sequentially disposed.

8. The method of claim 1, wherein a number of filters of the residual block is same as a number of filters of a fourth layer of the encoder.

9. The method of claim 1, wherein the residual blocks maintain the size of the activation map generated by the encoder and the number of channels.

10. The method of claim 1,
wherein the decoder includes a four deconvolution layers including a first layer, a second layer, a third layer and a fourth layer,
wherein a number of filters decreases from the first layer of the decoder to the fourth layer of the decoder, and
wherein a size of the filter increases or is the same from the first layer of the decoder to the fourth layer of the decoder.

11. The method of claim 10,
wherein each of the first to fourth layers of the decoder operates a batch normalization and a ReLU activation.

12. The method of claim 10, wherein a size of a filter of the second layer of the decoder is same as a size of a filter of the first layer of the decoder, and
wherein a number of filters of the second layer of the decoder is less than a number of filters of the first layer of the decoder.

13. The method of claim 12, wherein a size of a filter of the third layer of the decoder is same as the size of the filter of the second layer of the decoder, and wherein a number of filters of the third layer of the decoder is less than the number of filters of the second layer of the decoder.

14. The method of claim 13, wherein a size of a filter of the fourth layer of the decoder is greater than the size of the filter of the third layer of the decoder, and
wherein a number of filters of the fourth layer of the decoder is less than the number of filters of the third layer of the decoder.

15. The method of claim 14, wherein the number of filters of the first layer of the decoder is same as a number of filters of a third layer of the encoder,
wherein the number of filters of the second layer of the decoder is same as a number of filters of a second layer of the encoder, and
wherein the number of filters of the third layer of the decoder is same as a number of filters of a first layer of the encoder.

16. The method of claim 1, further comprising receiving the denoised result image and outputting a probability map using a discriminator.

17. The method of claim 16, wherein the discriminator includes a first layer, a second layer, a third layer, a fourth layer, a fifth layer and a sixth layer,
wherein sizes of filters of the first to sixth layers of the discriminator are same as each other, and
wherein a number of filters increases from the first layer of the discriminator to the fifth layer of the discriminator.

18. The method of claim 17, wherein the first layer of the discriminator is a convolution layer,
wherein a Leaky ReLU activation is operated in the first layer,
wherein the second to fourth layers of the discriminator are convolution layers,
wherein an instance normalization and the Leaky ReLU activation are operated in the second to fourth layers, and
wherein the fifth and sixth layers of the discriminator are convolution layers.

19. The method of claim 1, further comprising training a network based on a loss function representing a difference between the denoised result image and a normal-dose CT image (NDCT) which is a target image corresponding to the input image (the low-dose CT image, LDCT).

20. The method of claim 19, wherein an objective function LstatCNN(G) is formulated by combining a LDCT statistics loss Lstats(G) and a NDCT style transfer loss Lstyle(G),
wherein a control parameter is λₛₜₐₜₛ, and
wherein [symbol] _{statCNN}(G)= [symbol] _{style}(G)+λₛₜₐₜₛ [symbol] ₛₜₐₜₛ(G) is satisfied.

21. The method of claim 20, wherein the LDCT statistical loss represents a Euclidean distance between the denoised result image generated by the input image passing through the encoder, the residual blocks and the decoder and the target image, and
wherein the NDCT style transfer loss represents a difference between [symbol] ₁-norm of the denoised result image and [symbol] ₁-norm of the target image.

22. The method of claim 20, wherein the LDCT statistical loss Lstats(G) is [symbol] ₛₜₐₜₛ(G)= [symbol] _{(X,Y)}[(G(x)−y)^{T}Dₓ⁻¹(G(x)−y)],
wherein a sinogram bi calculated from a LDCT projection data is bᵢ=log(I₀/Iᵢ),
wherein Io is a blank photon intensity and Ii is a measured photon intensity,
wherein Iᵢ˜Poisson(I₀exp([−Axₜᵣᵤₑ]ᵢ)) is satisfied,
wherein A is a forward projection operator,
wherein a covariance matrix of b is Σ₁, =diag(σ_{b}_{₁}², . . . , σ_{b}_{ₘ}²),
wherein m(≥n) is a number of line integrals in the sinogram,
wherein if A^{†} denotes a left inverse of A and (A^{†})^{T} denotes a transpose of A^{†} , b≈Ax and x≈A^{†}b,
wherein a covariance matrix of x is Σₓ=A^{†}Σ_{b}(A^{†})^{T},
wherein A^{†}=A_{L}^{T}H,
wherein A_{L}^{T} denotes a locally weighted backprojection and H denotes a filter kernel,
wherein G(X) is the denoised result image and y is the target image, and
wherein Dx is a diagonal entries of Σx, Dₓ=diag(σₓ_{₁}², . . . , σₓ_{₁}²), σₓ_{₁}² is σₓ_{ᵢ}²=eᵢ^{T}A_{L}^{T}HΣ_{b}H^{T} A_{L}eᵢ and eᵢ is a unit vector of an i-th point image.

23. The method of claim 20, wherein the NDCT style transfer loss Lstyle(G) is [symbol] _{style}(G)= [symbol] _{(X,Y)}[∥G(x)−y∥ [symbol] ], and
wherein G(X) is the denoised result image and y is the target image.

24. A non-transitory computer-readable storage medium having stored thereon at least one program comprising commands, which when executed by a computer, performs the method of claim 1.

25. A system of statistical image restoration for a low-dose CT image using a deep learning, the system comprising:
an encoder configured to increase a number of channels of the low-dose CT image, which is an input image, and to decrease a size of an activation map of the low-dose CT image;
a plurality of residual blocks configured to pass the activation map generated by the encoder; and
a decoder configured to increase the size of the activation map passed through the residual blocks and to generate a denoised result image.

26. The system of claim 25, further comprising:
a discriminator configured to receive the denoised result image and to output a probability map.

27. The system of claim 25, wherein a network is trained based on a loss function representing a difference between the denoised result image and a normal-dose CT image (NDCT) which is a target image corresponding to the input image (the low-dose CT image, LDCT).
